(19) United States
(12) Patent Application Publication
(10) Pub. No.: US 2005/0281440 A1
(43) Pub. Date: Dec. 22, 2005

(54) Iris feature detection and sensor-based edge detection

(76) Inventor: Frederick A. Pemer, Santa Barbara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/871,220

(22) Filed: Jun. 18, 2004

(51) Int. Cl. G06K 9/00; G06K 9/48

(52) U.S. Cl. 382/117; 382/199

(57) ABSTRACT

An iris feature detector includes a reflexive eye movement source; a multiple image sensor; a controller, and a processor. The controller causes the eye movement source to cause rapid eye motion, and the sensor to capture first and second iris images over a time interval in which only an iris can move in the first and second images. The processor determines differences between the first and second images. The sensor may be integrated with the processor. The integrated sensor/processor is not limited to iris feature detection, and may be used for edge detection for machine vision and other applications.

### BACKGROUND

Biometric devices record physical characteristics (e.g., fingerprints, hand geometry, vein patterns, retinal patterns, iris patterns) and compare the measured characteristics to reference data. These devices may be used for a variety of biometric identification and authentication purposes. Biometric devices may be used to verify attendance in the work place, control physical access to restricted areas, and verify the identities of parties to transactions.

Biometric authentication addresses the ever-increasing need for security on government and corporate networks, the Internet, and public and private facilities. Biometric authentication offers advantages over conventional security measures such as passwords. Unlike passwords, biometric attributes are not easy to forget, and they are very difficult to duplicate.

Detecting iris patterns offer certain advantages over detecting other physical characteristics. The iris of the human eye contains multiple collagenous fibers, contraction furrows, coronas, crypts, rings, serpentine vasculature, striations, freckles, rifts and pits. The spatial relationship and patterns of these features can be detected and quantified. The patterns are sufficiently distinctive (i.e., it is highly improbable that two people will have the same pattern), they are relatively stable over age (the spatial relationship and patterns of an individual remain stable and fixed after an early age), and they are protected by the cornea. Unlike fingerprinting, iris patterns cannot be altered. Moreover, the iris patterns can be recorded by non-invasive methods.

A conventional iris scanner centers the eye in a field of view, creates one or more images of the eye, identifies an outer boundary of the iris in the images, extracts the image of the iris, scales and filters the extracted image, and generates a code corresponding to the iris. The code is transmitted to a personal computer, which performs identification or authentication by comparing the code to entries in a database. These iris scanners tend to be expensive. Detecting iris features is computationally intensive and can take a relatively long time. Using the detected iris features for identification and authentication is also computationally intensive and can also take a relatively long time

It is desirable to improve the performance and reduce the cost of detecting iris features. It is also desirable to reduce the time and complexity of using detected iris features for identification and authentication.

### SUMMARY

According to one aspect of the present invention, an iris feature detector includes a reflexive eye movement source; a multiple image sensor; a controller, and a processor. The controller causes the eye movement source to cause rapid eye motion, and the sensor to capture first and second iris images over a time interval in which only an iris can move in the first and second images. The processor determines differences between the first and second images.

According to another aspect of the present invention, an edge detector comprises a plurality of photosensor pixels. Each pixel includes a CMOS Active Pixel Sensor (APS); a first single-bit threshold detector and storage device for storing a first value that indicates whether an output of the APS indicates a bright value or dark value; a second single-bit threshold detector and storage device for storing a second value that indicates whether an output of the APS indicates a bright value or dark value; and a comparator for comparing the first and second values.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of an iris feature detector in accordance with an embodiment of the present invention.

FIG. 2 is an illustration of an object boundary in relation to an image sensor during operation of the iris feature detector.

FIG. 3 is an illustration of a method of controlling an iris feature detector in accordance with an embodiment of the present invention.

FIG. 4 is a method of processing first and second images in accordance with an embodiment of the present invention.

FIG. 5 is another illustration of an iris feature detector in accordance with an embodiment of the present invention

FIG. 6 is a circuit diagram of an edge detector pixel in accordance with an embodiment of the present invention.

FIG. 7 is an illustration of a method of controlling the edge detector in accordance with an embodiment of the present invention

FIG. 8 is an illustration of a machine vision system in accordance with an embodiment of the present invention.

### DETAILED DESCRIPTION

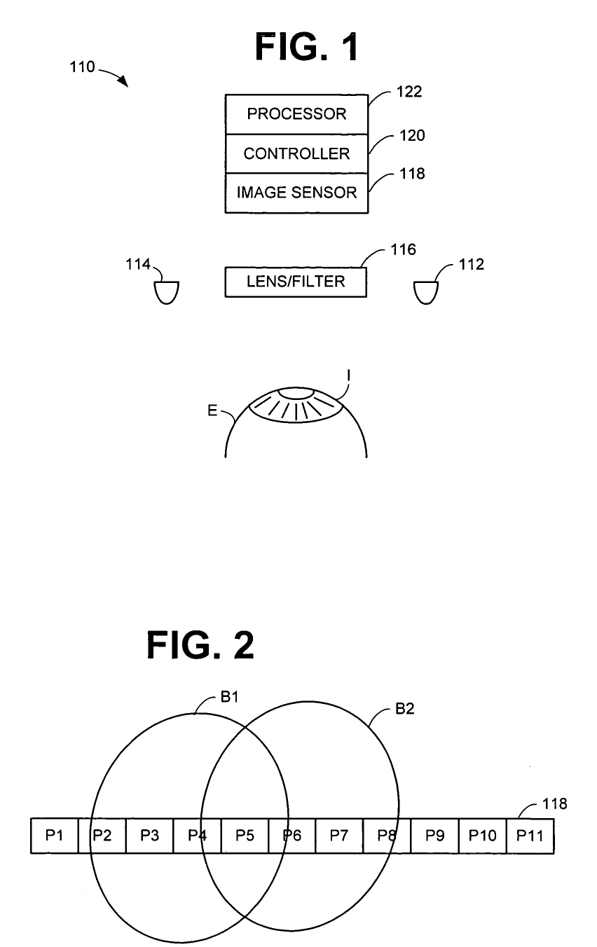

Reference is made to FIG. 1. An iris feature detector 110 includes a reflexive eye movement source 112-114, optics 116, a multiple image sensor 118, a controller 120, and a processor 122. The eye movement source 112-114 may include first and second light sources 112 and 114 for causing reflexive motion of a subject's eye (E). For example, each light source 112 and 114 may include one or more light emitting diodes.

The eye movement source 112-114 is positioned in front of a subject. One eye (E) of the subject is exposed to the eye movement source 112-114 and the image sensor 118.

The controller 120 causes the first light source 112 to illuminate, whereby the iris of the subject's eye is drawn to and becomes fixed on the illuminated first light source 112. Eye fixation may be presumed for a fixed interval after the first light source 112 has been illuminated, or it may be indicated by a manual input by an operator of the detector 110.

Once the eye (E) becomes fixed on the first light source 112, the controller 120 turns off the first light source 112 and immediately causes the second light source 114 to illuminate. Reflexively, the eye moves quickly and becomes fixed on the illuminated second light source 114. The “tracking interval” refers to the time interval between eye fixation on the first illuminated source 112 and eye fixation on the second illuminated source 114.

The optics 116 focuses an image of the subject's eye (E) onto the image sensor 118. During the tracking interval, the controller 120 causes the image sensor 118 to capture a first image of the eye and then a second image of the eye. For example, the first image may be taken as soon as the first light source 112 is turned on, and the second image may be captured immediately after the second light source 114 is turned on.

Each image shows the eye's iris (I) against a background. The background might include eye lashes, eye lids, or facial features. Since both images are captured during the tracking interval, and since eye tracking occurs very rapidly during the tracking interval, only the eye (E) moves from the first image to the second image. Eye lashes and other background information do not have enough time to move during the tracking interval.

FIG. 2 illustrates the motion of one feature within an eye with respect to the image sensor 118. The boundary of the feature in the first image is denoted by B1. The boundary in the second image is denoted by B2. Eleven pixels P1-P11 of the image sensor 118 are illustrated. The eye motion source 112-114 causes the feature boundary to move by a couple of pixels.

The processor 122 determines differences between the first and second images. Since the interval between the capture of the first image and the second image is long enough to allow the eye to respond to a change in the location of the stimulus light source and short enough to not capture a change in the position of the head, the only difference between the two sequentially captured images is the motion of the eye. The difference between the two images yields a pattern of edges of shapes (the iris) contained in the eye.

The edge pattern is not necessarily an accurate representation of the subject's iris, but it does not have to be. The pattern of edges is simply unique to an individual. Since the edge pattern does not have to be an accurate representation, the iris feature detector 110 does not require complex processing such as registration of the iris, extracting the iris from the background, artifact removal, etc. This results in faster detection of iris features, as well as faster processing for identification and authentication.

The processor 122 may have access to a database of reference patterns. After an edge pattern has been obtained, the processor 122 can search through the database and attempt to find a reference pattern that matches the just-acquired edge pattern. A match could be used to identify or authenticate the subject.

The processor 122 also indicates whether the eye (E) is alive, since the edge pattern is based on the physiological response of the eye (E). If the eye (E) is not alive, the first and second images will be the same, and an edge pattern will not be produced.

The image sensor 118 may be a CCD or CMOS sensor, provided that the CCD or CMOS sensor can capture the two images during the tracking interval. A standard CMOS sensor, for example, can capture two images in time periods as short as one microsecond. An image sensor 118 that can capture two images in an interval of about 100 microseconds to one millisecond should be sufficient. The sensor 118 of FIG. 2 is illustrated as a linear array of photodetectors simply to demonstrate the principle of the iris feature detector 110. In practice, the image sensor 118 has a two-dimensional array of photodetectors.

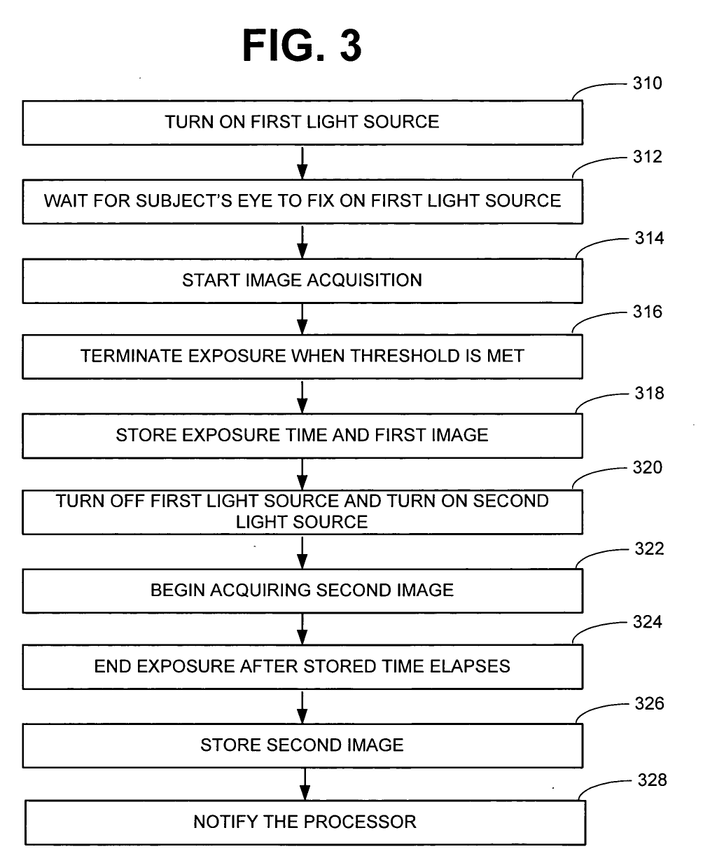

Reference is now made to FIG. 3, which illustrates the operation of the controller 120. The controller turns on the first light source (310), waits for the subject's eye (E) to fix on the first light source (312), and commands the image sensor to start acquiring the first image (314). During acquisition of the first image of the subject's eye, the sensor's photodetectors begin integrating a charge. When half of the photodetectors in the image sensor surpass a threshold, the exposure is terminated (316). The exposure time (that is, the time that image acquisition starts to the time the threshold is reached) and the first image are stored in memory (318).

The controller turns off the first light source and turns on the second light source (320), and commands the image sensor to begin acquiring the second image (322). Image acquisition is performed for an exposure time equal to the stored exposure time (324). Once the second image is acquired, it is stored in memory (326). The controller may then prompt the processor to process the first and second images (328).

Thus the controller performs exposure control while acquiring the first and second images. The exposure control is based on the amount of available light and the features of the image. The exposure control includes operating the sensor while varying the integration time until a predetermined exposure is indicated.

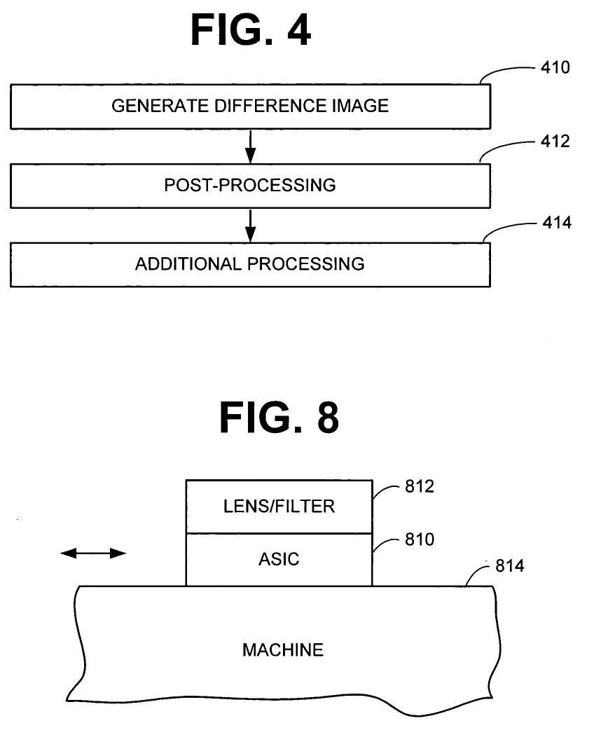

Reference is now made to FIG. 4, which illustrates the operation of the processor. The processor generates a “difference image” by taking differences between the first and second images (410). A pixel by pixel comparison may be performed. The value of a pixel in the first image is subtracted from the value of the pixel at the same spatial location in second image. Features that are stationary during the tracking interval will appear in the same location in both images. These stationary features will be subtracted out and, therefore, will not appear in the difference image. Features that move during the tracking interval (i.e., features of the iris) will not be at the same location in both images. Such features will appear in the difference image.

Referring once again to FIG. 2, the boundary of the feature moves from the first image to the second. Only the boundaries of the feature at the first position and the second position will appear in the difference image.

Returning to FIG. 4, the processor may perform post-processing on the difference image (412). Types of post-processing include, without limitation, scaling, mapping of edge features, classification of groups of edge features, and archiving.

The processor may perform additional processing on the difference image or send the difference image to a computer for additional processing (414). The additional processing may include authentication or identification. As a simple example, edge patterns for different people are detected and added to a database as reference patterns. The reference patterns include identifiers (e.g., names) and privileges (e.g., access allowed). During authentication or identification, iris features of a subject are detected, and an edge pattern is generated. The database is searched for a reference pattern that matches the edge pattern. If a match is found, the subject is identified or granted certain privileges.

The components of the iris feature detector 110 may be discrete components. For example, the light sources 112-114, the optics 116, the image sensor 118 and the controller 120 may be mounted on a single printed circuit board. The processor 122 may also be mounted to the circuit board. In the alternative, the image sensor 118 may supply the first and second images to a remote computer, which includes a processor 122 for generating an edge pattern.

The image sensor 118, controller 120 and processor 122 may instead be formed on a single chip. A single chip solution offers advantages over a multi-component system. The advantages include lower cost, lower power, smaller size, lighter weight, higher reliability, and better performance.

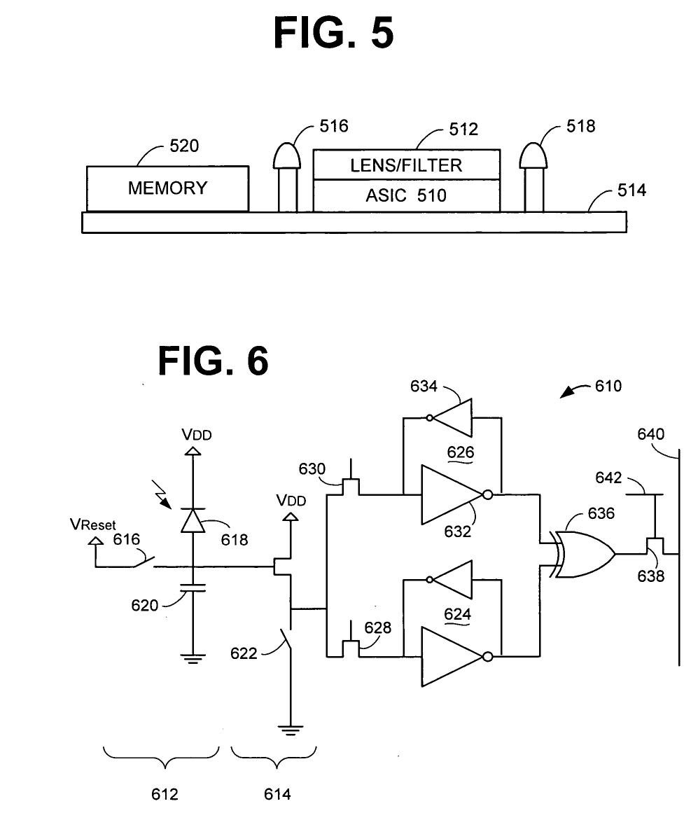

FIG. 5 illustrates one example of a single-chip solution for the iris feature detector. A single ASIC 510 includes an image sensor having a plurality of photosensor pixels. The processor is integrated with the image sensor. The ASIC 510 may also include the controller. The ASIC 510 may be covered with a lens/filter 512, and placed on a circuit board 514 along with two spaced-apart LEDs 516 and 518. The ASIC 510 and the two LEDs 516 and 518 are situated such that the image sensor captures enough of the iris to form a good image, and the LEDs 516 and 518 are spaced apart such that the movement of the eye causes the features of the iris to be captured by more than one pixel.

An additional light source (not shown) may be provided to illuminate the eye during iris detection. The additional light source may be mounted on the circuit board 514, or it might be external to the iris feature detector. For example, the additional source could be a halogen lamp. In the alternative, the LEDs 516 and 518 can be made to be very bright to illuminate the eye, making the additional light source unnecessary.

Senstivity of this device may be increased by operating more than one LED at a time. LEDs tend to emit monochromatic light. If several LEDs are grouped as a single light source and each LED is selected to emit a different color of light, then the color sensitivity of the iris edge detector will be improved.

The image sensor may be monochromatic. If, however, color is desired, a color filter may be added to the image sensor or several pairs of LEDs may be used, where each pair is of a different color.

Memory 520 may also be mounted to the printed circuit board 514. The memory 520 may be volatile memory (e.g., SRAM or DRAM). After the iris feature detector is turned on, but prior to searching the database, an external source (e.g., a personal computer) may load the volatile memory with reference patterns. In the alternative, the memory 520 may be non-volatile memory (e.g., Flash, MRAM, PRAM, write-once memory) that stores reference patterns and retains the reference patterns even after the iris feature detector is turned off.

Reference is now made to FIG. 6, which illustrates a single pixel of the integrated image sensor/processor. Each pixel includes a CMOS active pixel sensor (APS) 612 and shutter control 614. The CMOS APS 612 includes a reset switch 616, a photodiode 618, and an integrating capacitor 620. During a sensing operation, the reset switch 616 is closed and the integrating capacitor 620 is charged to a voltage equal to or less than Vreset. Then the reset switch 616 opened, and the photodiode 618 either charges or discharges the integrating capacitor 620 in proportion to the light collected by the photodiode 618.

After the exposure time has elapsed, a switch 622 of the shutter control 614 is closed. As a result, the integrating capacitor 620 is connected to either a first single-bit A/D converter and storage device 624, or a second single-bit A/D converter and storage device 626. This selection is made via first and second selector switches 628 and 630. The first single-bit A/D converter and storage device 624 compares the voltage stored on the capacitor 620 to a threshold voltage to perform a single bit analog to digital (A/D) conversion and stores the corresponding CMOS APS output when the first image is captured, and the second single-bit A/D converter detector and storage device 626 stores the CMOS APS output when the second image is captured.

Each single-bit A/D converter and storage device 624 and 626 may comprise a weak feedback CMOS latch including a large area (strong) inverter 632 driving a small area (weak) feedback inverter 634 with the output of the small inverter connected back to the input of the large inverter. Feedback from the weak feedback inverter 634 holds the state of the strong inverter 632 with the property that it is relatively easy to over drive the weak inverter 634 to change the state of the latch.

The weak feedback latch also converts an analog signal (the charge on the integrating capacitor 620) to a digital equivalent. When the input to the latch approaches approximately VDD/2, the latch can be forced into a Hi or Lo state. The threshold for this 1-bit A/D circuit is about VDD/2, input voltages below this threshold may represent a light pixel and above a dark pixel. Thus the threshold of the weak feedback latch is used to determine whether the analog value is above or below the threshold, i.e., whether it is a light or dark image. In this manner, the weak feedback latch functions as both a 1-bit A/D converter and a storage latch.

Transistor sizing, CMOS threshold voltage control, and the VDD applied to the weak feedback latch inverters all taken together determine the threshold voltage for the latch to change states. Gain within each weak feedback latch is controlled by sizing the transistors. The transistors of the strong inverter 632 may have a large width/length (W/L) ratio, and the transistors of the weak inverter 634 may have a small W/L ratio.

In the alternative, each single-bit A/D converter and storage device 624 and 626 may include a conventional A/D converter followed by a register or other conventional storage device.

Each photosensor pixel also includes a comparator 636 and pixel read out switch 638. The comparator 636 determines whether the first and second storage devices 624 and 626 store the same single-bit value. The comparator 636 may include an XOR logic gate 636. Since only the eye moves between the first and second image, features external to the eye will not record movement and those features will be rejected by the action of the XOR logic gate 636.

The pixel read out switch 638 connects the output of the XOR gate 636 to a bit line (640). The switch 638 is turned on and off via a word line 642.

The switches 616, 622, 628, 630 and 638 may include transistors. On/off signals for these switches 616, 622, 628, 630 and 638 may also be provided by a controller circuit (not shown) on the ASIC. The on/off signals cause all the pixels data to be processed simultaneously.

The switches 616, 622, 628, 630 and 638 form a part of the controller. Thus, a portion of the controller is also integrated with the image sensor and the processor.

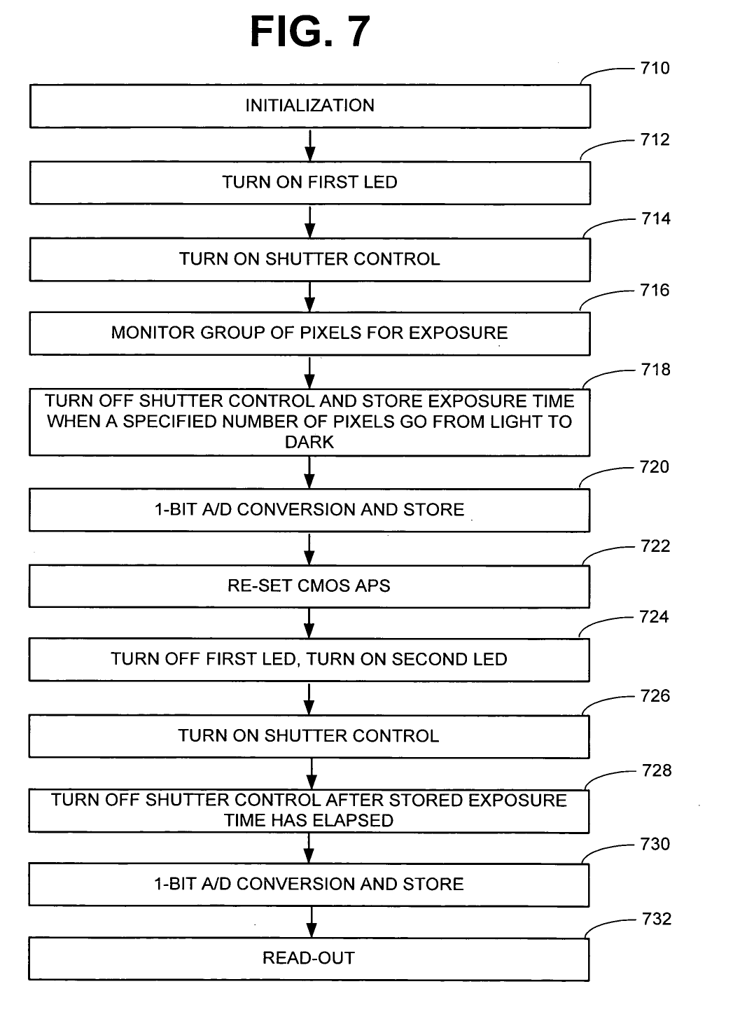

FIG. 7 illustrates the operation by the controller. Prior to image capture, the controller performs initialization (710). The controller resets the weak feedback latches to a Hi state by pulling the input of each weak feedback latch to a ground potential by selecting switches 622 and 628 or switches 622 and 630.

Capture of the first image follows. The controller turns on the first LED (712), and then turns on the shutter control of each pixel (714). The controller monitors a group of pixels for exposure (716). While the first image is being captured, the controller monitors the outputs of XOR gates for the group of pixels. When a specified number of pixels (e.g., 50%) go from light to dark, the controller turns off the shutter control of each pixel (to end image capture) and stores the time taken to reach the specified number of pixels (the exposure time) (718). The controller also turns on the first selector switch of each pixel, whereby the first image is converted to 1-bit data and stored in the first single-bit A/D converter and storage devices of the pixels (720).

Capture of the second image follows. During second image capture, the controller resets the APS (722), and turns off the first LED and turns on the second LED (724). Then the controller turns on the shutter control of each pixel to begin image capture (726). After the stored exposure time has elapsed, the controller turns off the shutter control (728) of each pixel and turns on the second selector switch of each pixel. At the end of the second exposure, the second image is converted to 1-bit data and stored in the second single-bit A/D converter and storage devices (730), and is available for read out through the XOR gates and the selected word lines. The controller reads out the edge pattern in parallel on the bit lines, one row at a time (732).

The ASIC 510 would generate the following bitstream for the images shown in FIG. 2. XOR represents the output of the XOR logic gate. A ‘1’ represents dark data, and a ‘0’ represents light data. In this example, the output of the XOR gate indicates a feature edge at pixels 2 and 3 and at pixels 8 and 9.

| Pixel | 1 | 2 | 3 | 4 | 5 | 6 | 7 | 8 | 9 | 10 | 11 |
|---|---|---|---|---|---|---|---|---|---|---|---|
| Img 1 | 0 | 1 | 1 | 1 | 1 | 1 | 1 | 0 | 0 | 0 | 0 |
| Img 2 | 0 | 0 | 0 | 1 | 1 | 1 | 1 | 1 | 1 | 0 | 0 |
| XOR | 0 | 1 | 1 | 0 | 0 | 0 | 0 | 1 | 1 | 0 | 0 |

The single bit representation at each pixel offers certain advantages. It allows large sensor arrays (e.g., 1M pixel) to scan the store a larger number of reference patterns in memory. The compact representation also allows a large number of reference patterns to be stored in the iris feature detector. By performing comparisons on-board, the edge pattern need not be transmitted to a remote computer. Consequently, identification or authentication can be performed much faster.

Since each photosensor pixel of the ASIC 510 has a processing circuit, the image processing can be performed in parallel. Parallel processing can reduce bandwidth bottlenecks, which are caused by the need to route word data (e.g., from rows of pixels or rows of memory) through data buses of a fixed width (e.g., 8 bits, 16 bits, 32 bits). This, too, increases processing speed.

An iris feature detector according to the present invention can be used in identification and authentication systems. Examples of the latter include ATM machines, security access points, devices that use biometric passwords, identification systems that only respond to a live eye, iris mapping and data collection systems, and other systems that use information from an iris scan.

The ASIC and the integrated sensor/processor are not limited to iris feature detectors. They can be used more generally for edge detection.

Referring to an example illustrated in FIG. 8, the ASIC or just the integrated sensor/processor 810 may be used for machine vision, where rapid edge detection of an object is important. A lens/filter 812 may be placed over the ASIC 810, and the ASIC 810 may be mounted to a machine 814. In this example, the object passes through the machine 814 and in the field of view of the sensor/processor 810. Only the motion of the object (the motion is represented by a double arrow) causes its edges to move in the first and second images. The parts of the machine 814 that are stationary will be rejected by the multiple images. Hence this sensor/processor 810 can be effective for identifying the motion of objects and to identify the shapes by edge detection of the moving objects.

Although several specific embodiments of the present invention have been described and illustrated, the present invention is not limited to the specific forms or arrangements of parts so described and illustrated. Instead, the present invention is construed according to the following claims.

1. An iris feature detector comprising:
a reflexive eye movement source;
a multiple image sensor;
a controller for causing the eye movement source to cause rapid eye motion and for causing the sensor to capture first and second iris images over a time interval in which only an iris can move in the first and second images; and
a processor for determining differences between the first and second images.

2. The detector of claim 1, further comprising memory for storing the first and second images, the processor determining the differences between the stored first and second images.

3. The detector of claim 1, wherein the eye movement source includes spaced-apart first and second light sources for causing the iris motion.

4. The detector of claim 3, wherein each light source includes several LEDs grouped together, each LED selected to emit a different color of light,

5. The detector of claim 3, wherein the controller causes the first and second light sources to illuminate alternately, and wherein the controller causes the image sensor to capture the first and second image during an eye tracking interval.

6. The detector of claim 1, wherein the controller further performs exposure control during capture of the first image.

7. The detector of claim 6, wherein the exposure control includes operating the sensor while varying integration time until a predetermined exposure occurs during acquisition of the first image.

8. The detector of claim 1, wherein an edge pattern is obtained from the differences.

9. The detector of claim 8, further comprising memory for storing at least one reference pattern; wherein the processor also compares the edge pattern to at least one reference pattern.

10. The detector of claim 1, wherein the processor is integrated with the sensor.

11. The detector of claim 10, wherein the sensor includes a plurality of photosensor pixels, each pixel including a CMOS APS, a first single-bit threshold detector and storage device for converting and storing the corresponding photodetector output when the first image is captured, a second single-bit threshold detector and storage device for converting and storing the corresponding photodetector output when the second image is captured, and a device for determining whether the first and second storage devices store the same single-bit value.

12. The detector of claim 11, wherein each threshold detector and storage device includes a single-bit A/D converter; and wherein the device for determining whether the first and second storage devices store the same single-bit value includes an XOR gate.

13. The detector of claim 11, wherein each threshold detector and storage device includes a weak feedback CMOS latch for performing A/D conversion and storage.

14. The detector of claim 1, wherein an ASIC includes the image sensor, the processor, and at least part of the controller.

15. Apparatus for detecting features of an iris, the apparatus comprising:
means for causing the iris to move rapidly from a first position and a second position;
means for capturing a first image of the iris at the first position and a second image of the iris at the second position such that head movement does not occur between the capture of the first and second images; and
means for creating an edge pattern from the first and second images, wherein creating the edge pattern includes identifying brightness differences between the first and second images;
whereby the edge pattern represents features in the iris.

16. The apparatus of claim 15, further comprising means for comparing the edge pattern to at least one reference pattern.

17. A method of scanning an iris, the method comprising:
causing the iris to move rapidly from a first position and a second position;
capturing a first image of the iris at the first position and a second image of the iris at the second position, the second image captured before background objects in the first and second images can detectably move; and
creating an edge pattern from the first and second images.

18. The method of claim 17, further comprising performing exposure control during capture of the first image.

19. The method of claim 18, wherein the images are acquired with a sensor; and wherein performing the exposure control includes operating the sensor while varying integration time until a predetermined exposure occurs during acquisition of the first image.

20. The method of claim 17, further comprising obtaining an edge pattern from the differences.

21. The method of claim 20, further comprising comparing the edge pattern to at least one reference pattern.

22. The method of claim 17, wherein creating the edge pattern includes using weak feedback latches to convert the images to third and fourth images having a single bit of data representing each pixel; and comparing the pixels of the third and fourth images.

23. An edge detector comprising:
an imaging device having a plurality of photodetectors; and
a processor for processing first and second images generated by the imaging device, the processor including a plurality of circuits, the circuits and the pixels having a one-to-one correspondence to the plurality of photodetectors, each circuit including a first single-bit threshold detector and storage device responsive to an output of the corresponding photodetector, a second single-bit threshold detector and storage device responsive to an output of the corresponding photodetector, and a comparator for comparing outputs of the first and second devices, whereby the comparison indicates whether an edge was imaged by the corresponding photodetector.

24. An edge detector comprising a plurality of photosensor pixels, each pixel including:
an active pixel sensor (APS);
a first single-bit threshold detector and storage device for storing a first value that indicates whether an output of the APS indicates a bright value or dark value;
a second single-bit threshold detector and storage device for storing a second value that indicates whether an output of the APS indicates a bright value or dark value; and
a comparator for comparing the first and second values.

25. The detector of claim 24, wherein each threshold detector and storage device includes a single-bit A/D converter.

26. The detector of claim 24, wherein each threshold detector and storage device includes a weak feedback CMOS latch for performing 1-bit A/D conversion and storage.

27. The detector of claim 24, wherein the device for determining whether the first and second storage devices store the same single-bit value includes an XOR gate; and wherein the device further includes a plurality of switches for controlling the detector.

28. A method of using the edge detector of claim 24, the method comprising monitoring a group of APS outputs during capture of a first image, and recording a time interval starting from the beginning of image capture to the time when a threshold number of the pixels in the group go from light to dark.

29. The method of claim 28, further comprising capturing a second image during the recorded interval.
